(19) United States
(12) Patent Application Publication
(10) Pub. No.: US 2014/0172721 A1
(43) Pub. Date: Jun. 19, 2014

(54) Method for Securing a Transaction

(71) Applicants: Dieter Weiss, Munich (DE); Michael Baldischweiler, Munich (DE)

(72) Inventors: Dieter Weiss, Munich (DE); Michael Baldischweiler, Munich (DE)

(73) Assignee: GIESECKE & DEVRIENT GMBH, Munich (DE)

(21) Appl. No.: 14/233,469

(22) PCT Filed: Jul. 17, 2012
(86) PCT No.: PCT/EP2012/003008

§ 371 Date: Jan. 17, 2014

(30) Foreign Application Priority Data
Jul. 19, 2011 (DE) 102011108069.8

(51) Int. Cl. G06Q 20/38

(52) U.S. Cl. CPC G06Q 20/382
USPC 705/64

(57) ABSTRACT

A method, a computer program product, a communication end device and a system for securing a payment transaction, between a communication end device and a server instance. The communication end device includes a processor with an insecure runtime environment and a secure runtime environment. The method includes setting up a first communication channel between the communication end device and the server instance; and sending transaction-relevant data from the communication end device to the server instance via the first communication channel. A second communication channel is set up between the browser application in the insecure runtime environment and a transaction application in the secure runtime environment, and the inputted transaction-relevant data is sent to the transaction application via the second communication channel. The transaction application generates from the received part of the transaction-relevant data a confirmation information item for securing the transaction employed for authorizing the transaction in the server instance.

This invention relates to a method, a computer program product, a communication end device as well as a system for securing a transaction, in particular a payment transaction, between a communication end device and a server instance.

Communication end devices are being employed more and more frequently, in the form of mobile telephones, smart phones or personal digital assistants, or PDAs, with a mobile telephone function, for carrying out transactions such as e.g. bank transactions, payment transactions, retrieval of data contents and the like. For this purpose, the communication end device engages in a data communication with a server instance.

A server instance will be understood in this application to be an instance locally remote from the communication end device. It may be for example a hardware or software server instance which makes available and offers on-line and other services. For the purposes of the application, the term “server instance” will include in particular an e-service, also designated as an on-line shop or web shop. E-services cover all services and activities that are created by means of computers and interactively offered and performed via electronic media, such as the Internet.

An e-service makes for example goods and digital products available on the Internet. Such an e-service comprises software with a virtual shopping cart functionality. The buyer selects the desired product by means of his communication end device. It is thereby deposited in a virtual shopping cart and marked for payment. Behind this e-service there is a physical store which actually processes the user's respective order.

All these e-services involve a transaction between the server instance and the communication end device. This transaction is a payment transaction, an identification transaction, an authentication transaction or the like. A transaction is understood here to be in particular a sequence of steps that can be regarded as a logical unit. In the course of the transaction and for the purpose of identification and authentication, a user frequently inputs security-critical or confidential input data to the user end device via an input device, such as e.g. a keyboard. Subsequently these input data are sent over the data communication network to the server instance as the transaction-relevant data. In the following step the server instance releases the service or product, which will be referred to hereinafter as transaction authorization.

In this connection there is the fundamental problem that personal or public mobile communication end devices equipped with a keyboard and screen, such as e.g. a smart phone, mobile phone or the like, as well as the data communication network are normally insecure and thus susceptible to malware. Malware refers to e.g. viruses, worms, trojans, spyware or the like which can intercept the transaction-relevant data or even tamper with them such that an unwanted transaction in favor of an unauthorized third party is carried out instead of the transaction intended by the user of the end device, without this being recognizable to the user, to the communication end device or to the server instance. When such a transaction has been tampered with, this can cause considerable damage to the server instance operator and also to the paying user.

EP 1 260 077 B1 hence describes a method by which a user of a mobile communication end device confirms a transaction. In so doing, the transaction system involves an authentication server which is employed for securing the transaction by the end device depositing an offer of the service provider automatically on the authentication server as a transaction confirmation. This is disadvantageous in so far as the mobile telephone can already have malware implanted thereon which tampers with the transaction confirmation accordingly. Moreover, the system is made more complex by the additional authentication server, resulting in extra costs.

For securing transactions over a data communication network there have been used for some time so-called secure runtime environments, also designated as Trusted Execution Environment® or TrustZone®. These secure runtime environments are employed for executing security-critical applications in an isolated environment secured against tampering.

Previous solutions require that the server instances make changes in their Internet presence in order to integrate the secure runtime environment into the processing of transactions. These changes are in particular the making available of further software and/or hardware modules or elaborate certification servers. These changes sometimes involve considerable costs, which is why transactions employing secure runtime environments are not yet widespread nowadays.

The invention is hence based on the object of simplifying transactions between communication end devices and server instances. In so doing, a high degree of security against tampering should nevertheless be given, and in particular no infrastructural adjustments should be necessary within the transaction system.

The object of the invention is achieved by the measures described in the equal-ranking independent claims. Advantageous configurations are described in the respective dependent claims.

The object is achieved in particular by a method for securing a transaction, in particular a payment transaction, between a communication end device and a server instance. The communication end device comprises a processor with an insecure runtime environment and a secure runtime environment. For the method, a first communication channel is initially set up between the communication end device and the server instance. Finally, transaction-relevant data are sent via the first communication channel from the communication end device to the server instance. The method according to the invention is characterized in that before the sending step a second communication channel is set up between the browser application in the insecure runtime environment and a transaction application in the secure runtime environment, and at least a part of the inputted transaction-relevant data is sent to the transaction application via the second communication channel. Before the sending step, the transaction application generates a confirmation information item from the received part of the transaction-relevant data. This confirmation information item is employed for authorizing the transaction. Authorization of the transaction means in particular a communication from the bank instance to the server instance.

Transaction-relevant data are primarily bank transaction data, in particular account number, bank code number, credit card number, credit card expiry date, name of the credit card owner, check code of the credit card, bank connections, transfer amounts and the like. These transaction-relevant data are requested by the server instance and either inputted by the user to the communication end device and/or generated by the transaction application or read out from a secure memory area of the secure runtime environment.

The bank instance is an instance that receives the transaction-relevant data from the server instance and compares them with the confirmation information items. After the comparison the bank instance generates a message to the server instance with the result of the comparison. Thereupon the server instance can decide whether to make available to the user the service or goods associated with the transaction.

The bank instance is for example a credit institution which offers payable services for funds transfer, credit transactions and capital transactions.

Furthermore, these transaction-relevant data can be security-critical or confidential data, or data that are requested by the server instance for carrying out the transaction, for example personal identification numbers (PIN), transaction numbers (TAN) or further transaction data, such as amount or order number of a product.

A communication between end device and server instance is understood here to be a signal transmission that is determined by the sender-receiver model. Information items are thus encoded into characters and transferred from a sender to a receiver via a communication channel.

The first communication channel is in particular over a mobile radio network. A mobile radio network is understood here to be a technical infrastructure on which the transfer of signals for mobile radio communication takes place. This refers substantially to the mobile switching network in which the transfer and switching of signals between stationary devices and platforms of the mobile radio network take place, as well as the access network (also designated as over-the-air interface) in which the transfer of signals between a mobile radio antenna and a mobile end device takes place. Examples to be mentioned are the Global System for Mobile Communications, or GSM, as a representative of the so-called second generation, or the General Packet Radio Service, or GPRS, and Universal Mobile Telecommunications System, or UMTS, as representatives of the so-called third generation of mobile radio networks, whereby in the third generation the mobile switching network is extended by the capability of a packet-oriented data transfer but the radio network itself is unchanged.

For performing a transaction, transaction-relevant data are sent from the communication device to the server instance.

The transaction-relevant data can be in particular the date, the amount, a transaction number which uniquely references the transaction, or the like. These transaction-relevant data can have been made available by the server instance at least partly via the first communication channel. These transaction-relevant data are sent to the transaction application at least partly via the second communication channel before the sending step.

In an alternative configuration according to the invention, at least a part of the transaction-relevant data is made available and/or generated by the transaction application.

The transaction-relevant data can, in a preferred configuration according to the invention, be inputted by the user into a browser application in the insecure runtime environment, with at least a part of the inputted transaction-relevant data being sent to the transaction application via the second communication channel before the sending step. For this purpose, the user inputs in particular the user name, the credit card number, the period of validity of the credit card, the check code CVV of the credit card and/or the credit card institution.

For sending the transaction-relevant data to the server instance, a browser application is provided. Because the browser application was started within the insecure runtime environment, the browser application is at risk of tampering, so that the transaction-relevant data must be monitored and confirmed in a certain form. For this purpose, the second communication channel to the secure runtime environment is set up, the transaction-relevant data are made available at least partly to the secure runtime environment, and a confirmation information item is generated within an environment that is protected from tampering.

In particular, the browser application has an extension module, a so-called browser plug-in. This extension module sets up the second communication channel between the browser application in the insecure runtime environment and the transaction application in the secure runtime environment, so that the transaction application in the secure runtime environment receives the part of the inputted transaction-relevant data for securing the transaction, and supplements or checks them, where applicable. The second communication channel extends exclusively within the processor. The extension module monitors the input in the insecure runtime environment and makes these data available to the secure runtime environment. The TEE has, in accordance with the requirements, a module at the protocol layer level which can pass data of the insecure runtime environment into the secure runtime environment. Such a module is distinct from the extension module, because the extension module is an extension of the browser application itself, i.e. a module at the level of the Application Layer.

For securing the transaction, the transaction application in the secure runtime environment accesses an input element of the communication end device. The sending of the transaction-relevant data to the server instance is effected only after the user has performed a confirmation input that is secured against tampering.

In an advantageous configuration, the transaction application in the secure runtime environment checks the inputted transaction-relevant data, in particular for consistency with data stored in the secure runtime environment. These stored data can be stored in a secure memory area or also within a security element, with the security element being connected to the secure runtime environment in terms of data communication. This communication can be contact-type or contactless. The security element may be a portable data carrier with a corresponding security functionality, such as e.g. a smart card, chip card, token, mass memory card, MultiMediaCard, or the subscriber identification card, or SIM, or alternatively an identification data carrier such as for example an electronic national identity card or passport with the user's machine-readable identification data stored on a chip. The security element is configured in particular as a hardware component and arranged as a firmly integrated constituent in the mobile end device, whereby it cannot in such a form be removed from the mobile end device, for example as an M2M module, co-processor. Alternatively, the security element is a software component in the form of a secure memory area in the secure runtime environment.

Upon an ascertained inconsistency of the transaction-relevant data with data from the security element, the transaction application displays a corresponding warning message to the user via an output element of the communication end device. Alternatively or additionally, it prevents the sending of the transaction-relevant data to the server instance. Thus, the user is informed in a manner secured against tampering, or the transaction is prevented upon a possible malware attack.

Advantageously, the confirmation information item also contains data of the browser application, in particular data about the first communication channel and/or further transaction-specific data. For example, confirmation information items are a URL or the IP address of the server instance. Additionally, the place, date and further data identifying the transaction can also enter into the confirmation information item.

In an advantageous configuration, the confirmation information item contains at least partly an information item identifying the secure runtime environment. This can be for example an identification number that was uniquely assigned to the secure runtime environment and made known to the bank instance. Alternatively, the confirmation information item is encrypted with a cryptographic key, with the server instance being able to decrypt this confirmation information item again. Alternatively, a transaction-relevant datum is linked uniquely with the secure runtime environment, this linkage having been communicated to the server instance prior to the transaction.

In a preferred configuration, the transaction application in the secure runtime environment sets up a third communication channel to the bank instance and sends the confirmation information item to the bank instance before the transaction-relevant data are sent to the server instance. This confirmation information item is requested by the server instance. The server instance compares the confirmation information item with the sent transaction-relevant data and, in dependence on the comparison, releases or prevents the service connected with the transaction.

In an alternative configuration, the transaction application codes the confirmation information item into the transaction-relevant data. The transaction-relevant data with the coded-in confirmation information item are subsequently made available to the browser application. The transaction-relevant data with the coded-in confirmation information item are sent to the server instance as the transaction-relevant data. In particular, the confirmation information item is coded into a user-specific part of the credit card number, thereby generating a changed credit card number. In particular, the changed credit card number is sent to the server instance as part of the transaction-relevant data, instead of the credit card number. Because the user has already performed the input of the transaction-relevant data, it is unnecessary to display the changed credit card number again, so as not to confuse the user. The server instance recognizes by the changed number that the credit card number contains a confirmation information item and decodes the credit card number accordingly.

The idea of the invention further includes a computer program product which can be loaded directly into the internal memory of a processor within a digital communication end device, and comprises software code portions with which the steps of the method described here are performed when the computer program product runs on the processor.

Further, the object is achieved by a communication end device having means for carrying out the described method. The end device has for this purpose a processor unit with an insecure runtime environment and a secure runtime environment; an input unit for inputting transaction-relevant data; an output unit for outputting transaction-relevant data; as well as a first interface for setting up a first communication channel and sending transaction-relevant data. The end device has in particular a browser application in the insecure runtime environment with an extension module, this extension module having a second interface for setting up a second communication channel to a transaction application in the secure runtime environment. The transaction application accesses at least parts of the inputted transaction-relevant data via the second communication channel to generate a confirmation information item for securing the transaction.

Further, the object is achieved by a system having means for carrying out the described method. The system has a communication end device described here, a server instance and a bank instance. In particular, the communication end device has a secure runtime environment. This secure runtime environment is uniquely identifiable by means of a cryptographic key on the system.

Hereinafter the invention, or further embodiments and advantages of the invention, will be explained more closely with reference to figures, the figures only describing exemplary embodiments of the invention. The same parts in the figures are provided with the same reference signs. The figures are not to be considered true to scale; individual elements of the figures may be represented with exaggerated size or exaggerated simplicity.

There are shown:

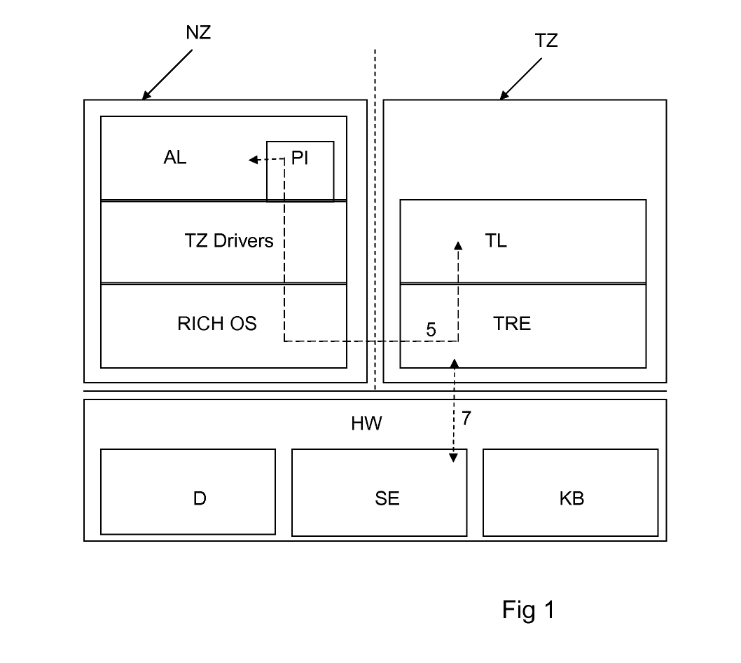

FIG. 1 a schematic representation of a processor configured in a communication device according to the invention

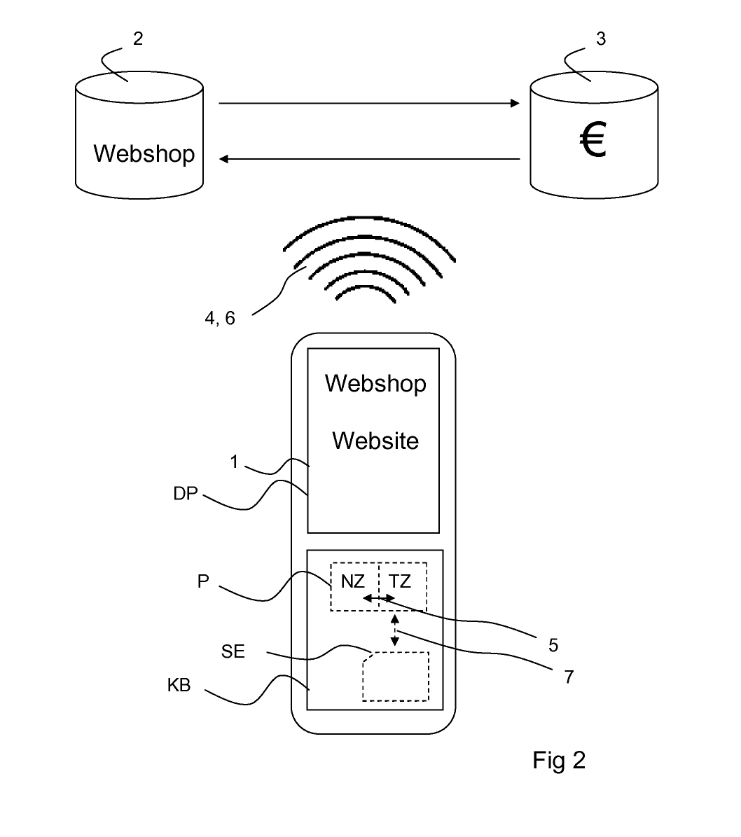

FIG. 2 a schematic representation of a system according to the invention

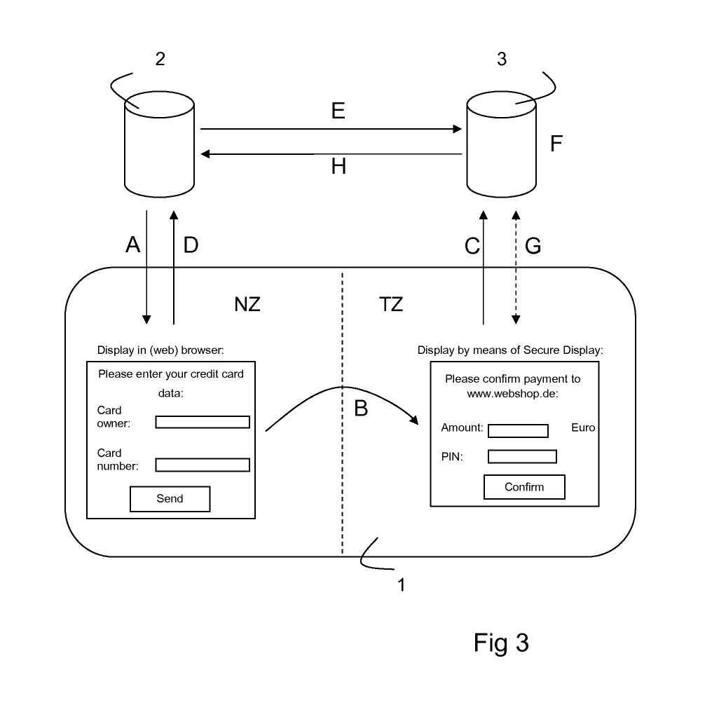

FIG. 3 a schematic representation of a first exemplary embodiment of the method according to the invention

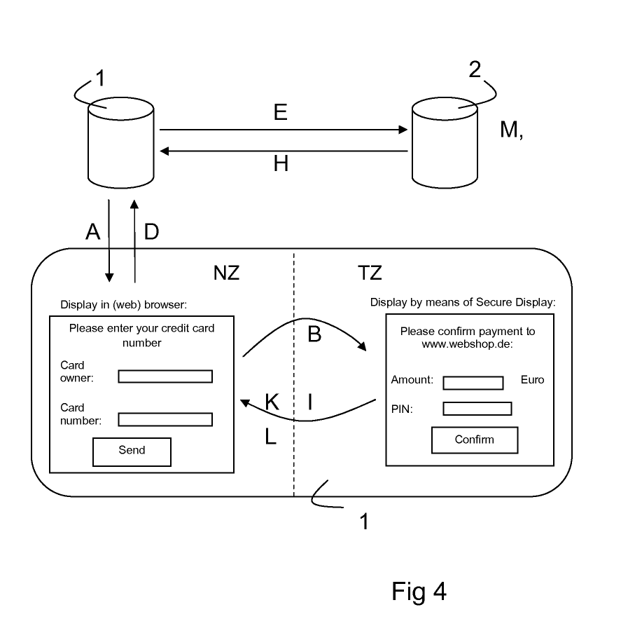

FIG. 4 a schematic representation of an exemplary embodiment of the method according to the invention that is alternative to FIG. 3

FIG. 1 shows a processor P configured in a communication end device 1 according to the invention. The generating of the confirmation information item is effected according to the invention within a secure runtime environment TZ. This secure runtime environment TZ is for example an ARM TrustZone® in a mobile radio end device 1. The ARM TrustZone® is a known technology with which there is generated in the processor P a protected area which is employed as a secure runtime environment TZ for carrying out security-critical applications, so-called trustlets TL. For this purpose, the ARM TrustZone® is implemented in a hardware platform HW of a mobile communication device 1. This hardware platform HW comprises possibilities of accessing a display screen D, a keyboard KB and, where applicable, also a security element SE, for example a SIM or a mass memory card with a security functionality.

A memory area in the communication end device 1 is subdivided into an insecure memory area and a secure memory area and contains a runtime environment. The runtime environment loads applications AL, also designated as applets, and runs them on the hardware platform HW. Basic and main functions of a runtime environment are reading, writing, sorting and searching for files, transporting data over a communication network, controlling input elements, for example the keyboard KB or a microphone, as well as controlling output elements, for example the display screen KB or a loudspeaker.

In the insecure memory area an insecure runtime environment NZ, also designated as normal zone, is executed, while in the secure memory area the secure runtime environment TZ is executed. In the insecure runtime environment one or several applications AL, also designated as applets, have been stored and are started from the normal runtime environment NZ. One or several drivers (=TZ system driver and TZ API) as well as an operating system (“rich OS”) are likewise arranged in the insecure memory area. In an attack scenario there are located in the insecure runtime environment NZ, besides the applications AL, also malware applications which are able to spy out and change the data inputted by means of the input element KB. In order for the user not to notice the attack, the output element D might also be affected by the attack, so that false information is displayed to the user.

In the secure memory area TZ the operating system of the secure runtime environment TRE (=TrustZone runtime environment) runs, as well as one or several security-relevant applications, so-called trustlets TL.

Besides the ARM TrustZone® technology represented in FIG. 1, other technologies for isolating secure runtime environments can also be applied to the procedure described here. For example, there can be effected a virtualization in a so-called embedded system. Products to be used in this connection may be for example from the companies Trango® and Open Kernel Labs®.

A part of the invention is constituted by an extension module PI of a browser application. This extension module, also designated as a plug-in, establishes a second communication channel 5 between the browser application AL and the transaction application TL for securing the transaction.

FIG. 2 represents a system according to the invention with which the transactions can be secured. The communication end device 1 according to the invention as described in FIG. 1 is represented again here. As already described in FIG. 1, the end device 1 has a processor P with secure and insecure runtime environments TZ, NZ. Additionally an input element KB and an output element D are provided. For securing a transaction according to the invention there is again provided a browser application AL with an extension module PI which can set up a second communication channel 5. Additionally the end device 1 is equipped with a security element SE, moreover the secure runtime environment can set up a fourth communication channel 7 in order to take further securing measures, for example the check of a PIN inputted by the user, which is stored as a reference PIN in the SE.

The system further comprises a server instance 2, here in the form of a web shop, and a bank instance 3.

There are offered by the server instance 2 for example information services and educational services, such as e-education, e-learning, e-teaching, e-publishing, e-book, e-zine and e-catalog, or procurement services, commerce services and order services such as e-business, e-commerce, e-procurement, e-cash, e-shop, e-intermediary, e-auction, or cultural and administrative services such as e-culture, e-government or e-vote, which the user wishes to utilize with his end device 1. For this purpose, the user starts the browser application AL to set up a first communication channel 4 to the server instance 2, which is effected for example in the form of a http request through the browser application AL.

The browser application AL, also called a web browser, is in this connection a special application for displaying web pages on the Internet. While the web browser AL is executed in the insecure runtime environment NZ, the transaction application TL is located within the secure runtime environment TZ. Thus, the transaction application TL cannot be attacked by malware that might be located on the communication end device 1.

A user wishing to utilize the transaction application according to the invention by means of secure runtime environment TZ must have installed the extension module PI. This can be done for example by the user himself together with the installation of an “app” on the communication end device 1, which the user can download either from a server instance 2 where he wishes to procure services, or from a bank instance 3 via which the payment transaction is physically processed.

Preferably, this “app” is made available by the provider of the payment method, hereinafter designated as bank instance 3. Within the framework of the downloading of the “app” or after its installation, the bank instance 3 is informed about which transaction-relevant data are linked with which secure runtime environment TZ. The transaction-relevant data, in particular the data of the credit card, are identified in so doing on the basis of the usual card data, such as owner, number, expiry date, check code, etc. The secure runtime environment is in turn uniquely identified on the basis of a cryptographic key K_{Applet} which was either generated in the secure runtime environment and communicated to the bank instance 3 or alternatively generated by the bank instance and made available to the secure runtime environment TZ.

After the installing of the extension module PI an association of transaction-relevant data and a unique identification of the secure runtime environment TZ is given at the bank instance. Likewise, the transaction-relevant data are known to the secure runtime environment TZ.

Furthermore, it is known to the bank instance 3 that transactions that are carried out with the user's end device 1 are secured with the secure runtime environment. This is important in order that the request for payment arriving at the bank instance 3 from the server instance 2 can be processed properly in the bank instance 3.

According to FIG. 3, a first exemplary embodiment of the invention will now be explained more closely. Thus, a browser application AL sets up a first communication channel 4 to the server instance 2.

Shopping on the Internet by means of end device 1 now takes place for the user in the usual way: The user selects the service, product or goods on the web page of the server instance 2. The server instance 2 now asks the user in the step A to pay for the selected goods and hence outputs an HTML form into which the user is to enter the transaction-relevant data, in particular credit card data. Alternatively, the user has the data inserted automatically by the browser by means of “auto-completion” or by the trustlet TL.

The browser plug-in PI recognizes in the step B that a payment operation has now been triggered and sets up a second communication channel 5 in order to monitor the transaction-relevant data entered into the HTML form fields. This can be done either continually, i.e. after each keystroke on the input element KB, or preferably upon sending off of the HTML form, i.e. when the user has activated the “send” button in the browser application. When the HTML form has initially been completely filled in and subsequently the browser plug-in PI activated for transferring the inputted transaction-relevant data to the secure runtime environment TZ (step B), these data are already present in their final form and the user has already indicated that he does not wish to make any further change in them.

The browser plug-in PI now searches the HTML form fields for the transaction-relevant data that are to be checked/monitored. For this purpose, the searched-for/monitored transaction-relevant data, for example the credit card number, can have been stored either in the browser plug-in PI itself, i.e. in the insecure runtime environment NZ, or in the secure runtime environment TZ. In the latter case, the browser plug-in PI calls up the transaction application TL of the secure runtime environment TZ at each sending off of an HTML form, in order that this transaction application TL can search the HTML form fields for the corresponding transaction-relevant data.

When the transaction-relevant data are found in an HTML form field, the sending off of the HTML form data is prevented by the browser plug-in PI. Subsequently, the transaction application TL initiates the measures for securing the transaction, which is also represented in the step B in FIG. 3. In addition to the inputted transaction-relevant data, the transaction application TL receives from the browser plug-in PI further data of the browser application, for example the URL, i.e. the website displayed in the browser, or the IP address of the server instance 2. Additionally, the place, date and further data identifying the transaction can also be made available to the secure runtime environment TL by the browser plug-in.

In the simplest case, the transaction application TL now displays a tamper-proof dialog, for example:

“Do you really want to perform the desired transaction at www.serverinstanz.de”

The dialog can now also show parts of the transaction-relevant data again. The output element D can be driven for this dialog only via the secure runtime environment TZ, so that any output is generated by the secure runtime environment TZ. The user can thus be sure that the repeated output is secured against tampering. The user can now check the repeated output with the transaction-relevant data previously entered into the HTML form and, in the case of inconsistent data, prevent the transaction at this point. The outputting of data to an output element by means of a secure runtime environment TZ in a manner secured against tampering is described for example by DE 102011018431, filed on 21 Apr. 2011 by the same applicant, express reference being made to the entire description thereof.

The user of the end device 1 is now requested to answer the dialog. The answer is effected via an input by means of the input element KB. The input element KB can be driven for this dialog only via the secure runtime environment TZ, so that any input with regard to this dialog is verified by the secure runtime environment TZ. Thus, the dialog can be answered exclusively via a tamper-proof input by the user. The inputting of data by means of a secure runtime environment TZ in a manner secured against tampering is described for example by DE 102010052666.5, filed on 26 Nov. 2010 by the same applicant, express reference being made to the entire description thereof.

Instead of a yes/no answer to answer the dialog, the user can also be asked to re-enter parts of the transaction-relevant data, for example the amount and credit card check code. This has two advantages. Firstly, the user becomes aware of the amount to be paid. If the end device 1 is otherwise secured accordingly, the input of a PIN or the like might not be required. Secondly, it is not trivial to filter parts of the transaction-relevant data out of the multiplicity of different web pages of individual server instances 2. Thus, this dialog with re-entering would be an elegant method for the transaction application TL to receive parts of the transaction-relevant data.

Alternatively, a PIN or equivalent information, in particular a password, or a biometric fingerprint can also be requested from the user.

The transaction application TL generates from the transaction-relevant data received by means of the second communication channel 5 a confirmation information item which is encrypted with the cryptographic key K_{Applet} of the secure runtime environment TZ. A confirmation information item is structured for example as follows:

Confirmation information item=enc(URL_{webshop}∥Amount,K_{Applet})Credit card number

The credit card number is appended without encryption. Alternatively, the confirmation information item can itself in turn be encrypted again, in order that nobody else can read the credit card number upon the data transfer.

The transaction application TL now sends the confirmation information item to the corresponding bank instance 3, for example a credit card provider. For this purpose, the transaction application TL sets up a third communication channel 6. This channel 6 can be configured in an arbitrary way, for example SMS or via Internet protocol. This is represented in FIG. 3 by step C. The bank instance 3 can be easily found out on the basis of the available credit card number, thereby enabling the end device to set up the channel in a targeted manner.

For setting up the channel 6 there is employed for example the Bank Identification Number, or BIN, also designated as Issuer Identification Number UN. The BIN is employed for example for identifying credit cards and debit cards upon routing within automatic teller machine networks. On the basis of the BIN the employed type of card and the bank instance 3 that has issued the respective payment card can be identified. A BIN possesses international validity. The exact structure of the BIN is described in the standard ISO 7812. In the case of a 16-digit credit card number, the first six digits represent the BIN. Alternatively, there are BIN search engines for finding out for example the BIN of an EC/Maestro card. This information can also be stored in the trustlet TL upon the installing of the TL. This would avoid a search.

Thus, the transaction application TL has a list of the telephone numbers of the bank instances 3 in order to transfer an SMS with the confirmation information item via the third communication channel 6. If the channel 6 is set up alternatively by means of Internet protocol IP, the transaction application TL has, through the BIN, a list of the URLs or IP addresses of the bank instances 3.

When the confirmation information item has been sent to the bank instance, the browser plug-in causes the sending of the transaction-relevant data to the server instance according to step D, thereby sending off for example the http request via the first communication channel 4. On receipt of the transaction-relevant data, the operator of the server instance 2 contacts the bank instance 3 according to step E of FIG. 3 in order to have the transaction-relevant data checked and to obtain the outstanding sum of money.

The bank instance 3 now checks in the step F whether a confirmation information item of a secure runtime environment TZ is required for the corresponding credit card number. If this is so, the bank instance 3 compares whether a confirmation information item with the same transaction-relevant data, for example name and URL of the server instance 2 and the same amount, is present from a secure runtime environment TZ. If the comparison yields a match, the transaction is authorized by the bank instance 3. Thus, in the step H the server instance receives the result of the comparison, through which the server instance makes available the product, goods or service to the user of the end device 1.

If the comparison in the step F yields that the transaction-relevant data of the server instance do not match the data of the confirmation information item, the bank instance 3 can, according to step G, make queries via the channel 6 still set up, or alternatively again contact a third communication channel 6 via the telephone number transmitted with the SMS or alternatively the received IP address in order to make queries according to step G.

FIG. 4 represents an alternative method to FIG. 3 for securing a transaction. The steps A and B are identical with the steps A and B of FIG. 3.

As in FIG. 3, the transaction application TL in the secure runtime environment TZ generates the confirmation information item. This confirmation information item is not sent directly to the bank instance 3 (step C of FIG. 3), however, but coded into the transaction-relevant data, for example the credit card number.

A credit card number consists of a ten-digit owner-specific part and the six-digit BIN. The six-digit part of the credit card number should remain unchanged in order that a usual plausibility check of the transaction-relevant data, for example for typing mistakes, can be carried out unchanged in the server instance 2.

The owner-specific part of the credit card number is now employed to code in the confirmation information item. When all ten decimal places of the owner-specific part of the credit card are employed for coding, a confirmation information item with an amount of data of about 32 bits can be coded in.

As one of many possibilities for coding in transaction-relevant data as a confirmation information item in 32 bits, a possibility will be explained hereinafter wherein the confirmation information item consists for example of the amount to be paid and the URL of the server instance 2. This coding-in corresponds to the step I of FIG. 4.

The amount to be paid is expressed in binary form. Numerical values over 42 million can be coded into a 32-bit data word where two decimal places must be considered, because it holds that

Maximum numerical value=2*exp(32)/100.

The URL of the server instance 2 is hashed to 32 bits. The result is encrypted with the cryptographic key K_{Applet} of the secure runtime environment TZ.

Confirmation information item=enc(owner-specific part of credit card number EXOR amount EXOR hash(URL_{webshop}),K_{Applet})

In contrast to the method according to FIG. 3, no further encryption of the confirmation information item is necessary here.

The thus generated confirmation information item again has 32 bits, which is expressed in ten decimal places. The ten-digit owner-specific part of the credit card number is now replaced with the ten-digit confirmation information item, thereby obtaining a changed credit card number. Subsequently, the check digit of the credit card is recomputed.

The browser plug-in PI receives in the step K of FIG. 4 the changed credit card number from the transaction application TL of the secure runtime environment TZ and replaces the inputted credit card number with the changed credit card number at the corresponding place in the HTML form field of the browser application Al. Because the user has already pressed the “Send” button, it is expedient to suppress the changed credit card number according to step L, so that the user does not see the changed credit card number. This prevents the users of the end device 1 from being confused.

The server instance 2 now receives the transaction-relevant data with the coded-in confirmation information item via the first communication channel 4 according to step D. The server instance 2 now passes on these received data as usual to the bank instance 3 according to step E. The bank instance 3 recognizes on the basis of the transaction-relevant data, for example the owner's name, that these transaction-relevant data could have been generated by a transaction application TL of a secure runtime environment TZ and specifically the credit card number contains a coded-in confirmation. The bank instance 3 likewise computes the changed credit card number with the previously received cryptographic key K_{Applet} and the transaction-relevant data (URL, amount) received from the server instance 2. If the computed changed credit card number matches the changed credit card number received from the server instance 2, the transaction is authorized and the server instance 2 is informed of the consistency of the data, see step H.

### LIST OF REFERENCE SIGNS

1 Mobile communication end device, smart phone
P Processor
NZ Insecure runtime environment
TZ Secure runtime environment, TrustZone
TZ-ID Identification number of TZ, K_{Applet}
OS Operating system of insecure runtime environment
TRE Operating system of secure runtime environment, MobiCore
TL Trustlet, application within TZ
AL Applet, application within NZ
PI Plug-in, extension module of an AL
HW Hardware platform
SE Security element
KB Keyboard, input element
DP Display screen, output element
2 Server instance, web shop
3 Bank instance, payment service provider
4 First communication channel, mobile radio network
5 Second communication channel, within the processor
6 Third communication channel, mobile radio network
7 Fourth communication channel, outside the processor
A Start of payment operation
B Recognition of transaction by means of browser plug-in and triggering of check by means of TZ
C Confirmation information item to payment service provider
D Sending of transaction-relevant data, credit card data
E Passing on of transaction-relevant data and web shop data
F Comparison between transaction-relevant data/web shop data and confirmation information item
G Queries in case of inconsistent data
H Information about successful payment operation
I Coding of credit card number with confirmation information item (amount, recipient, TZ-ID of TZ) and reception of changed card number
K Insertion of changed credit card number in (web) browser
L Suppression of changed credit card number
M Computation of changed credit card number on the basis of web shop data and TZ-ID

1-17. (canceled)

18. A method for securing a payment transaction, between a communication end device and a server instance, the communication end device comprising a processor with an insecure runtime environment and a secure runtime environment, the method including the steps of:
setting up a first communication channel between the communication end device and the server instance;
sending transaction-relevant data from the communication end device to the server instance via the first communication channel, wherein:
before the sending step a second communication channel is set up between the browser application in the insecure runtime environment and a transaction application in the secure runtime environment;
before the sending step at least a part of the transaction-relevant data is sent to the transaction application via the second communication channel;
before the sending step the transaction application generates from the received part of the transaction-relevant data a confirmation information item for securing the transaction; and
wherein the confirmation information item is employed for authorizing the transaction in the server instance.

19. The method according to claim 18, wherein the confirmation information item also contains data of the browser application about the first communication channel and/or further transaction-specific data.

20. The method according to claim 18, wherein the transaction-relevant data are entered by the user into a browser application in the insecure runtime environment and before the sending step at least a part of the entered transaction-relevant data is sent to the transaction application via the second communication channel.

21. The method according to claim 18, wherein at least a part of the transaction-relevant data is made available by the server instance via the first communication channel and before the sending step at least a part of the inputted transaction-relevant data is sent to the transaction application via the second communication channel.

22. The method according to claim 18, wherein at least a part of the transaction-relevant data is made available and/or generated by the transaction application.

23. The method according to claim 18, wherein the transaction application:
checks the transaction-relevant data in the secure runtime environment;
if the check yields an inconsistency of parts of the transaction-relevant data:
displays a warning message to the user via an output element of the communication end device; and/or
prevents the sending of the transaction-relevant data to the server instance.

24. The method according to claim 18, wherein the confirmation information item contains an information item uniquely identifying the secure runtime environment.

25. The method according to claim 18, wherein:
the transaction application in the secure runtime environment sets up a third communication channel to the bank instance; and
the confirmation information item is sent to the bank instance while employing parts of the transaction-relevant data, before the transaction-relevant data are sent to the server instance.

26. The method according to claim 25, wherein
the server instance sends the transaction-relevant data received from the communication end device to the bank instance at least partly;
the bank instance compares the confirmation information item with the transaction-relevant data sent by the server instance; and
the bank instance authorizes or prevents the transaction in dependence on the comparison.

27. The method according to claim 18, wherein the transaction application:
codes the confirmation information item into the transaction-relevant data;
makes the transaction-relevant data with the coded-in confirmation information item available to the browser application; and
the transaction-relevant data with the coded-in confirmation information item are sent to the server instance as the transaction-relevant data.

28. The method according to claim 27, wherein the confirmation information item is coded into an owner-specific part of a credit card number, thereby generating a changed credit card number.

29. The method according to claim 28, wherein the changed credit card number is sent to the server instance as part of the transaction-relevant data, instead of the credit card number.

30. The method according to claim 18, wherein the transaction application in the secure runtime environment encrypts the transaction-relevant data cryptographically by means of a key associated with this secure runtime environment.

31. The method according to claim 18, wherein an affiliation of at least parts of the transaction-relevant data, and the secure runtime environment was communicated to a bank instance before the first-time performance of the method.

32. A computer program product which can be loaded directly into the internal memory of a processor within a digital communication end device and comprises software code portions with which the steps according to claim 18 are performed when the computer program product runs on the processor.

33. A communication end device having means for carrying out the method according to claim 18 and having:
a processor unit with an insecure runtime environment and a secure runtime environment;
an input unit for inputting transaction-relevant data;
an output unit for outputting transaction-relevant data;
a first interface for setting up a first communication channel and sending) transaction-relevant data;
wherein a browser application in the insecure runtime environment has an extension module, and this extension module has a second interface for setting up a second communication channel to a transaction application in the secure runtime environment, and the transaction application can access at least parts of the inputted transaction-relevant data via the second communication channel in order to generate a confirmation information item for securing the transaction.

34. A system having means for carrying out the method according to claim 18, having:
a communication end device;
a server instance; and
a bank instance;
wherein the communication end device has a secure runtime environment and this secure runtime environment is identifiable uniquely by means of a cryptographic key on the system.
